(19) United States
(12) Patent Application Publication
(10) Pub. No.: US 2022/0228433 A1
(43) Pub. Date: Jul. 21, 2022

(54) TILT ANGLE ADJUSTING DEVICE FOR SLATS OF A VENETIAN BLIND

(71) Applicant: WEI-SHUN HONG, CHANGHUA COUNTY (TW)

(72) Inventor: WEI-SHUN HONG, CHANGHUA COUNTY (TW)

(21) Appl. No.: 17/149,916

(22) Filed: Jan. 15, 2021

(51) Int. Cl. E06B 9/323; E06B 9/322

(52) U.S. Cl. CPC E06B 9/323; E06B 9/322

(57) ABSTRACT

A venetian blind includes a top frame receiving a coiling and uncoiling mechanism for folding and unfolding slats. An adjusting mechanism is mounted to the top frame for adjusting a tilt angle of each slat and includes two pivotal casing. Each of two ends of each pivotal casing includes two opposite outer sides to which two ladder strings are disposed, respectively. Each ladder string has a lower end extending through and secured to each slat. Two side strings are wound around the coiling and uncoiling mechanism. Each side string has a lower end extending through each slat and fixed to the bottommost slat. Each side string is hooked by an actuating member to extend through a spacing between two pegs parallel to an axial direction of each tube. Each actuating member interlocks with an associated pivotal casing to move in unison in a circumferential direction.

### BACKGROUND OF THE INVENTION

The present invention relates to a window blind and, more particularly, to a tilt angle adjusting device for slats of a venetian blind.

Window blinds essentially block the sunlight and protect privacy in modern living rooms as well as providing decoration or manifesting the taste of the living rooms. A typical venetian blind includes a plurality of slats that can tilt through adjustment. Thus, venetian blinds remain popular while many new window blinds are developed.

A typical venetian blind includes a top frame receiving a coiling and uncoiling mechanism for folding and unfolding the slats of the venetian blind. Furthermore, an adjusting mechanism is provided to adjust the tilt angle of each slat. Tilting of each slat for adjusting the tilt angle essentially depends on actuation and interlocking of the adjusting mechanism during adjustment. However, uniform movement of all slats from top to bottom during tilting is difficult, because each slat has its own weight. The bottommost slat often creates resistance to the tilt of all slats. Thus, uniform movement of the slats is difficult, such that light rays might still enter, which is not required when blocking light is required.

Taiwan Utility Model No. M595687 discloses a venetian blind including a housing, a blind body, a tilt angle adjusting device, and a first pull string. The housing is substantially a parallelepiped defining a long axis, a short axis extending perpendicularly to the long axis, with the short and long axes located on the same horizontal plane, and a longitudinal axis extending perpendicularly to the long axis and extending in a direction the same as a normal to the horizontal plane. The long axis extends through left and right ends of the housing. The short axis extends through front and rear sides of the housing. The longitudinal axis extends through upper and lower sides of the housing. The blind body is located below the housing and includes a plurality of slats and a lower end portion located at the lowest portion of the slats and disposed correspondingly to the housing. The tilt angle adjusting device includes a shaft unit and a ladder string unit. The shaft unit is disposed in the housing in a direction parallel to the long axis. The ladder string unit includes at least two ladder strings. Each ladder string includes a front warp and a rear warp spaced from the front warp, with the front and rear warps extending in directions parallel to the longitudinal axis and spaced from each other. A plurality of wefts extends between the front and rear warps, such that each ladder string presents a lattice-ladder structure. Each slat is disposed on a respective weft, such that the slats below the housing are vertically spaced from each other in the longitudinal axis. The front and rear warps are connected to the shaft unit and can be driven by the shaft unit to move relative to each other in the longitudinal axis, thereby tilting the slats. The first pull string extends through the front side or the rear side of each slat. An upper end of the first pull string interlocks with the shaft unit, and the lower end of the first pull string is connected to the lower end portion of the blind body. When the shaft unit is driven, the first pull string and the front or rear warps on the same side with the first pull string will be released or coiled into the housing while the shaft unit is being driven, and the slats and the lower end portion tilt while the shaft unit is being driven.

The above conventional mechanism has its technical status but has a complicated structure. Furthermore, the displacements of the first pull string and the associated front or rear warps while the shaft unit is being driven are synchronously coiled into or uncoiled out of the housing by the same length. Namely, the coiled length is substantially the same. Thus, when it is desired to tilt the lower end portion of the blind body, the same coiled length must be achieved. As a result, the efficiency and effect should be improved.

### BRIEF SUMMARY OF THE INVENTION

In view of the above drawbacks of the prior art, an objective of the present invention is to provide a venetian blind comprising a top frame receiving a coiling and uncoiling mechanism for folding and unfolding a plurality of slats of a slat unit. An adjusting mechanism is mounted to the top frame and is configured to adjust a tilt angle of each of the plurality of slats. The adjusting mechanism includes two pivotal casing each having a tube in a central portion thereof. Each tube includes a polygonal inner periphery. An adjusting rod extends through the tubes, is securely fixed in the tubes, and has an outer periphery corresponding to the polygonal inner periphery of each tube, permitting driving of the two pivotal casings. Each of two ends of each of the two pivotal casings includes two opposite outer sides to which two ladder strings are disposed, respectively. Each of the two ladder strings has a lower end extending through and secured to each of the plurality of slats. Two side strings are wound around an outer periphery of the coiling and uncoiling mechanism. Each of the two side strings has a lower end extending through each of the plurality of slats and fixed to the bottommost slat of the slat unit. Two pegs are disposed in the top housing, are spaced from each other, and extend in a direction parallel to an axial direction of each tube. Each of the two side strings is hooked by an actuating member to extend through a spacing between the two pegs. Each actuating member interlocks with an associated pivotal casing to move in unison in a circumferential direction. Each actuating member moves together with the associated pivotal casing to change an angular position and an orientation thereof in the circumferential direction.

In the present invention, since one of the two side strings extending through the spacing between the two pegs is pulled upwards, a small extent of pulling can create a double-length pulling effect, thereby easily tilting the bottommost slat by lifting one ladder string and releasing the other ladder string. Since the lower end of the pulled side string pulls the bottommost slat upwards, tilting of the released side of the bottommost slat can be easily achieved by lifting one ladder string and releasing the other ladder string. This avoids leakage of light when blocking light is required.

In addition to effecting the above pulling and releasing, the present invention further focuses on that when one of the two side strings is pulled by a length, two sections extending through the spacing between the two pegs are pulled at the same time. Thus, when one of the two side string pulls the bottommost slat, the pulling is carried out with a larger amount of pulled length. Thus, in the present invention, the doubled pulled length is achieved in terms of pulling and tilting.

Accordingly, in use of the present invention, rotation of the adjusting rod (extending through the tubes of the pivotal casings) through a small angle is sufficient to easily pull and tilt the bottommost slat. By using one of the two side strings (extending through the spacing between the two pegs) for pulling purposes, a small extent of pulling can create a “double length” pulling effect, such that one ladder string is pulled upwards, and the other ladder string is released. As a result, the released side of the bottommost slat can easily tilt, avoiding leakage of light when blocking light is required.

The present invention will become clearer in light of the following detailed description of illustrative embodiments of this invention described in connection with the drawings.

### DESCRIPTION OF THE DRAWINGS

FIG. 1 is a perspective view of a venetian blind of an embodiment according to the present invention.

FIG. 2 is a perspective view of an adjusting mechanism, a coiling and uncoiling mechanism, and side strings exposed outside of a housing of the venetian blind of FIG. 1.

FIG. 3 is a perspective view of the adjusting mechanism of FIG. 2.

FIG. 4 is a side view of the adjusting mechanism of FIG. 3.

FIG. 5 is a diagrammatic view similar to FIG. 4, illustrating operation for tilting slats in a direction.

FIG. 6 is a diagrammatic view similar to FIG. 4, illustrating operation for tilting slats in another direction.

FIG. 7 is a diagrammatic view illustrating tilting of slats of the venetian blind.

FIG. 8 is another diagrammatic view illustrating tilting of slats.

FIG. 9 is a perspective view illustrating tilting of the bottommost slat.

FIG. 10 is another perspective view illustrating tilting of the bottommost slat.

### DETAILED DESCRIPTION OF THE INVENTION

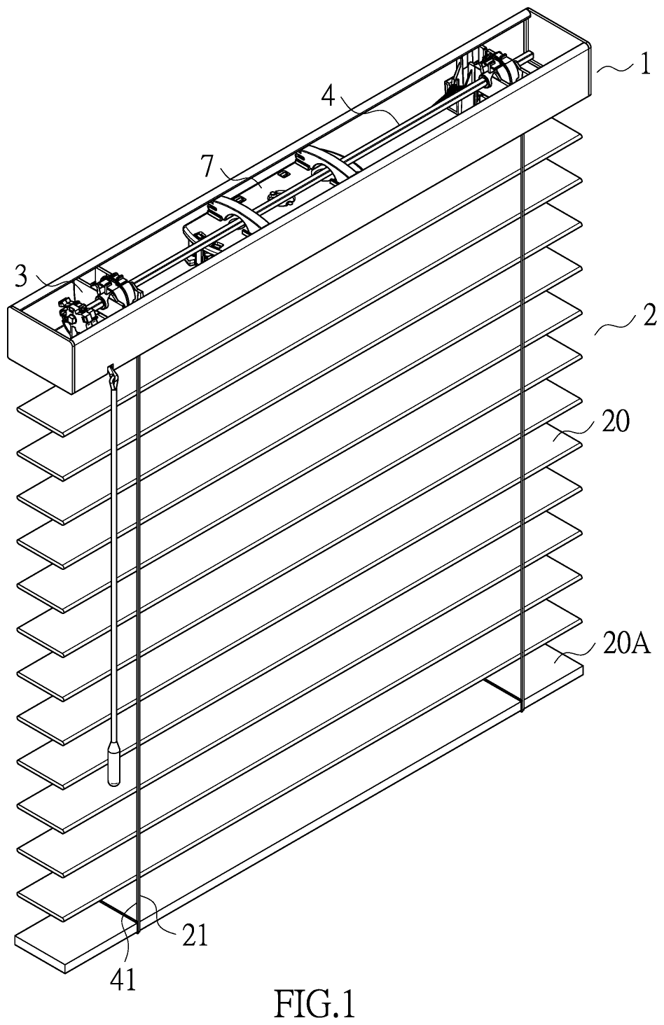

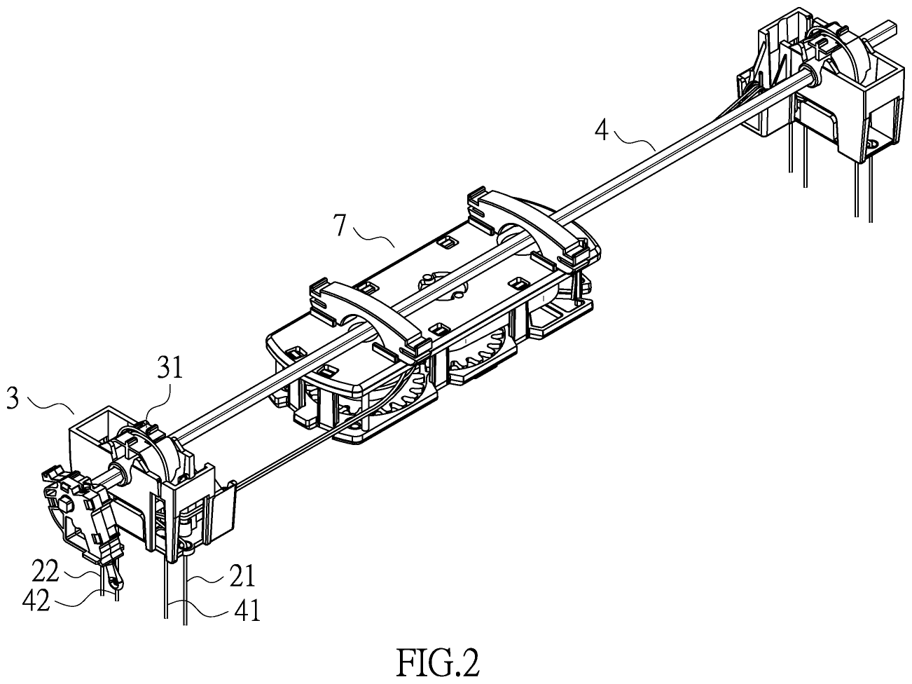

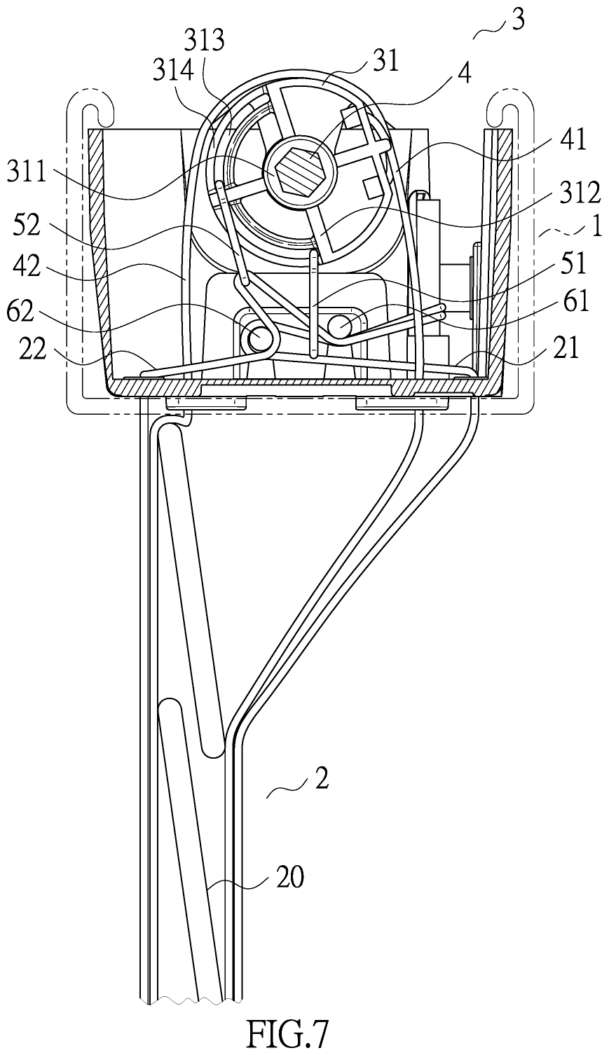

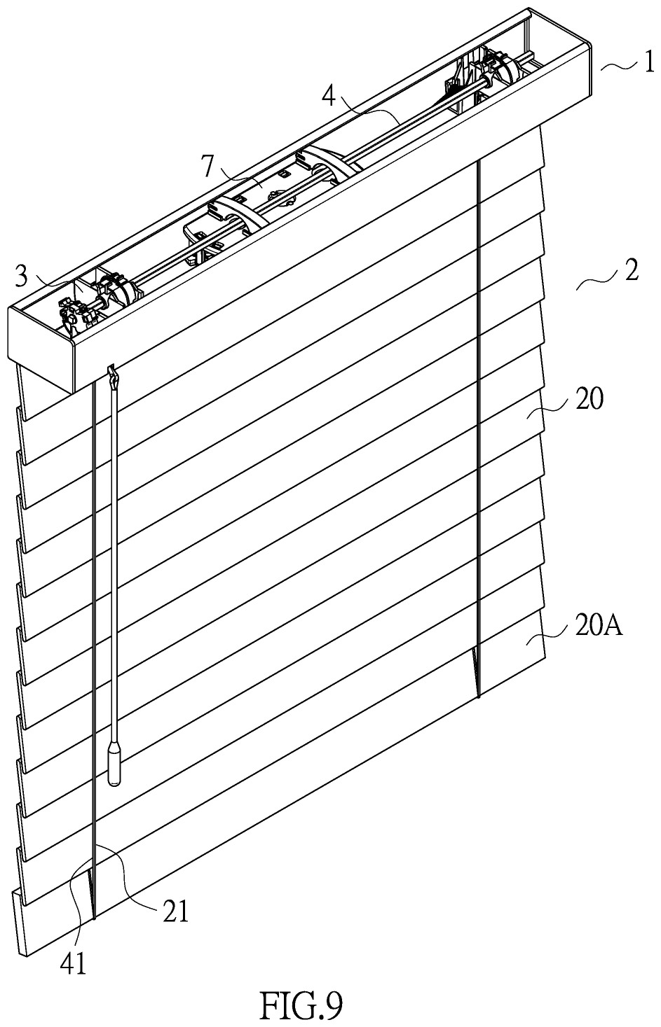

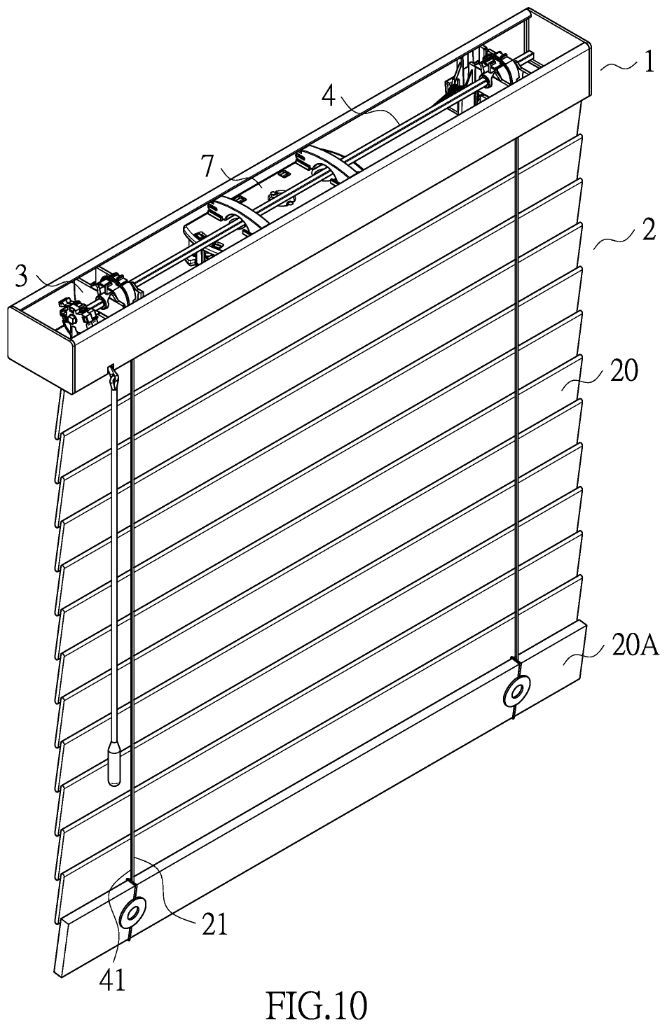

With reference to FIGS. 1 and 2, a venetian blind of an embodiment according to the present invention comprises a top frame 1 receiving a coiling and uncoiling mechanism 7 for folding and unfolding a slat unit 2. An adjusting mechanism 3 is mounted to the top frame 1 and is configured to adjust a tilt angle of each of a plurality of slats 20 of the slat unit 2 (see FIGS. 7 and 9 and FIGS. 8 and 10).

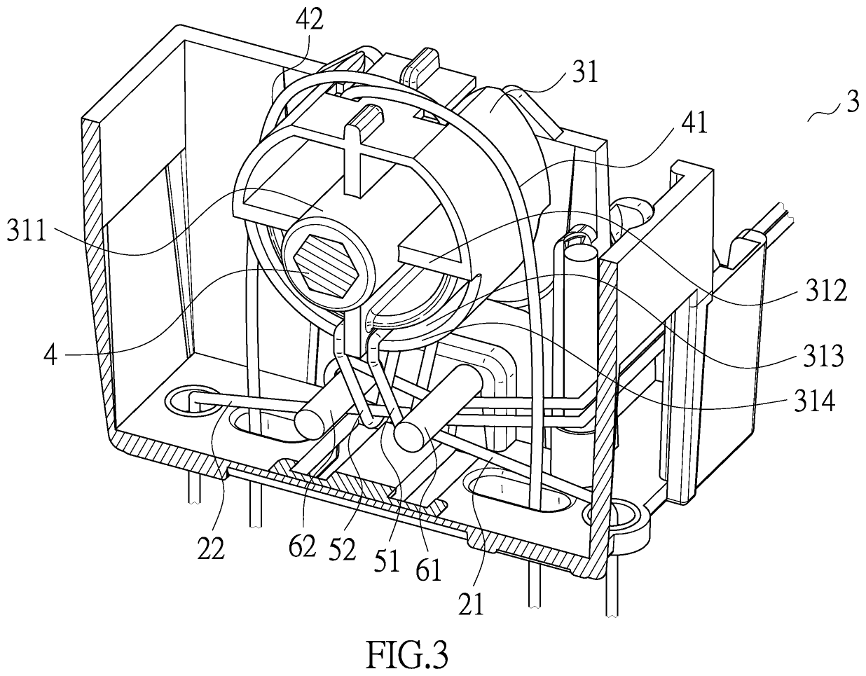

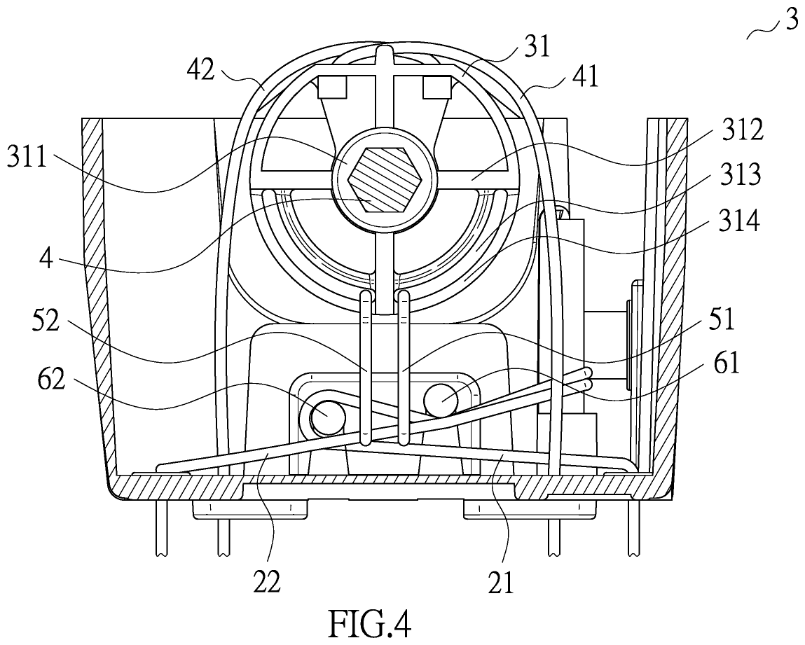

With reference to FIGS. 3 and 4, the adjusting mechanism 3 includes two pivotal casing 31 each having a tube 311 in a central portion thereof. Each tube 311 includes a polygonal inner periphery. An adjusting rod 4 extends through the tubes 311, is securely fixed in the tubes 311, and has an outer periphery corresponding to the polygonal inner periphery of each tube 311, permitting driving of the two pivotal casings 31. Each of two ends of each of the two pivotal casings 31 includes two opposite outer sides to which two ladder strings 41 and 42 are disposed, respectively. Each of the two ladder strings 41 and 42 has a lower end extending through and secured to each of the plurality of slats 20, as shown in FIG. 7 showing the ladder string 41 (but the other ladder string 42 is not shown).

Two side strings 21 and 22 are wound around an outer periphery of the coiling and uncoiling mechanism 7. Each of the two side strings 21 and 22 has a lower end extending through each of the plurality of slats 20 and fixed to the bottommost slat 20A of the slat unit 2, as shown in FIG. 7.

Two pegs 61 and 62 are disposed in the top housing 1, are spaced from each other, and extend in a direction parallel to an axial direction of each tube 311. Each of the two side strings 21 and 22 is hooked by an actuating member 51, 52 to extend through a spacing between the two pegs 61 and 62. Each actuating member 51, 52 interlocks with an associated pivotal casing 31 to move in unison in the circumferential direction. Each actuating member 51, 52 moves together with the associated pivotal casing 31 to change an angular position and an orientation thereof. Each side string 21, 22 is lifted or lowered by a doubled pulled length.

It is noted that the side strings 21, 22 are pulled upwards after extending through the spacing between the two pegs 61 and 62, and the other end of each side string 21, 22 pulls the bottommost slat 20A upwards.

Since one of the two side strings 21 and 22 extending through the spacing between the two pegs 61 and 62 is pulled upwards, a small extent of pulling can create a double-length pulling effect, thereby easily tilting the bottommost slat 20A. Since the lower end of the pulled side string 21, 22 pulls the bottommost slat 20A upwards, the ladder strings 41 and 42 can easily tilt the bottommost slat 20A. This avoids leakage of light when blocking light is required.

The present invention more focuses on that when one of the two side strings 21, 22 is pulled by a length, two sections extending through the spacing between the two pegs 61 and 62 are pulled at the same time. Thus, when the side string 21, 22 pulls the bottommost slat 20A, the pulling is carried out with a larger amount of pulled length. Thus, in the present invention, a double pulled length is achieved in terms of pulling and tilting.

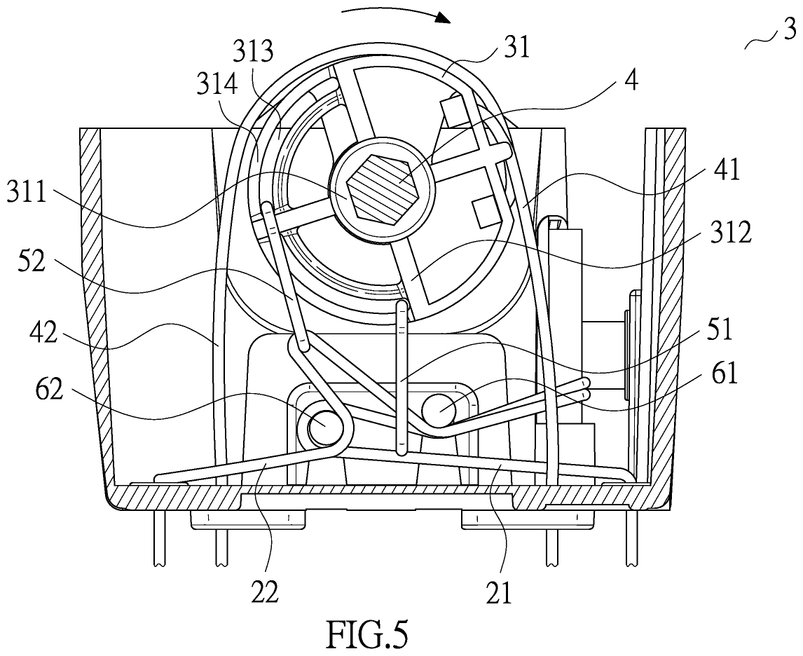

With reference to FIGS. 2-5, when the adjusting rod 4 extending through the tubes 311 of the pivotal casings 31 is used to tilt each slat 20 (for blocking light) in a clockwise direction shown in FIG. 5, since the two ladder strings 41 and 42 are fixed to the outer peripheries of the two pivotal casings 31, the ladder string 42 is lifted, and the ladder string 41 is released. Since the lower end of each ladder string 41, 42 extends through and is secured to each slat 20, the slats 20 tilt to a state for blocking light, as shown in FIG. 7.

On the other hand, when the pivotal casings 31 pivot in the circumferential direction, since the side string 22 is hooked by the actuating member 52 to extend through the spacing between the two pegs 61 and 62 and since the actuating member 52 interlocks with the associated pivotal casing 31 to move in unison in the circumferential direction, the actuating member 52 moves together with the tube 31 in the clockwise direction and is pulled upwards. Furthermore, since the side string 22 is fixed to the bottommost slat 20A, the bottommost slat 20A can tilt to block the light. In the present invention, upward pulling of the string 22 (extending through the spacing between the two pegs 61 and 62) by a small length is sufficient to create a “double length” pulling effect. Thus, the ladder string 42 is pulled upward, and the other ladder string 41 is released, thereby easily tilting the bottommost slat 20A.

It is noted that the side string 22 extending through the spacing between the two pegs 61 and 62 is pulled upwards by a length, two sections extending through the spacing between the two pegs 61 and 62 are pulled at the same time. Thus, when the string 22 pulls the bottommost slat 20A upwards, the pulling is carried out with a larger amount of pulled length, achieving a double pulled length in terms of pulling and tilting. Thus, a small extent of rotation of the adjusting shaft 4 extending through the tubes 311 of the pivotal casings 31 is sufficient to easily lift and tilt the bottommost slat 20A. As a result, when the slats 20 tilt, the bottommost slat 20A can easily achieve the light-blocking effect. By upward pulling of the side string 22 extending through the spacing between the two pegs 61 and 62, the ladder string 42 is pulled upwards, and the other ladder string 41 is released, thereby easily tilting the bottommost slat 20A.

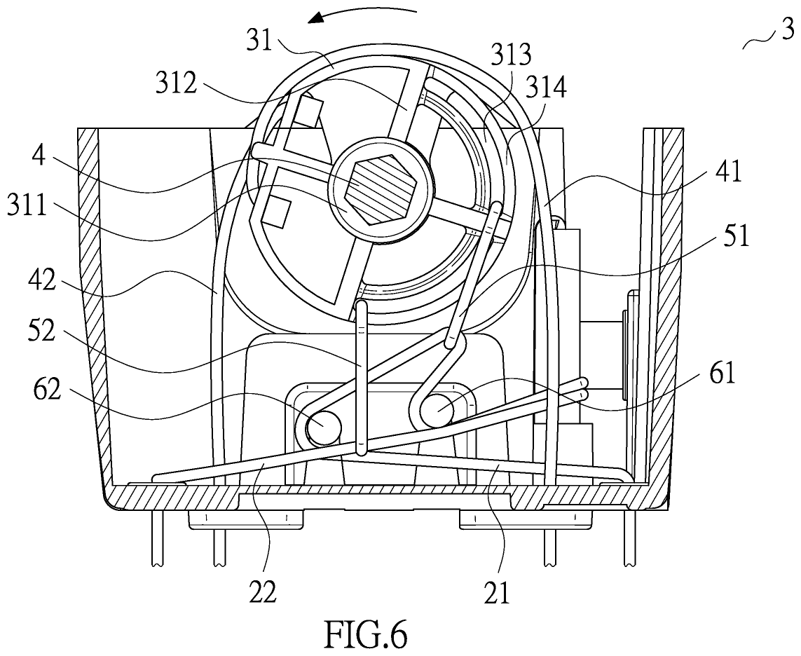

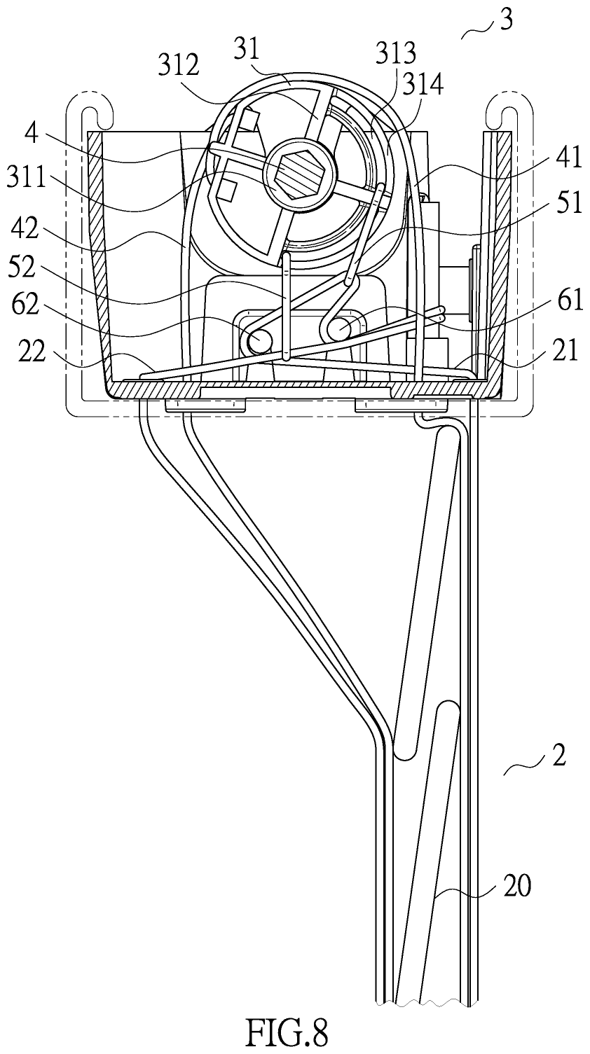

With reference to FIGS. 3, 4, and 6, when the adjusting rod 4 extending through the tubes 311 of the pivotal casings 31 is used to tilt each slat 20 (for blocking light) in a counterclockwise direction shown in FIG. 6, since the two ladder strings 41 and 42 are fixed to the outer peripheries of the two pivotal casings 31, the ladder string 41 is lifted, and the ladder string 42 is released. Since the lower end of each ladder string 41, 42 extends through and is secured to each slat 20, the slats 20 tilt 180° in another direction to a state for blocking light, as shown in FIG. 8. Pulling the side string 22 (extending through the spacing between the two pegs 61 and 62) to a small length is sufficient to create a “double pulled length” pulling effect. Thus, ladder string 42 is pulled upward, and the other ladder string 41 is released, thereby easily tilting the bottommost slat 20A.

On the other hand, when the pivotal casings 31 pivot in the circumferential direction, since the side string 21 is hooked by the actuating member 51 to extend through the spacing between the two pegs 61 and 62 and since the actuating member 51 interlocks with the associated pivotal casing 31 to move in unison in the circumferential direction, the actuating member 51 changes its position while the actuating member 51 moves together with the pivotal casing 31 in the circumferential direction. As a result, the bottommost slat 20A tilt 180° in another direction to a state for blocking light.

In the above situation, since the string 22 extending through the spacing between the two pegs 61 and 62 is pulled upwards by a length, two sections extending through the spacing between the two pegs 61 and 62 are pulled at the same time. Thus, when the string 22 pulls the bottommost slat 20A upwards, the pulling is carried out with a larger amount of pulled length, achieving a double pulled length in terms of pulling and tilting.

In the present invention, each actuating member 51, 52 interlocks with the associated pivotal casing 31 to move in unison in the circumferential direction and, thus, move together with the associated pivotal casing 31 in the circumferential direction to change its position. In a preferred embodiment, each of the two pivotal casings 31 has an arcuate groove 313 at an inner side of a peripheral thereof. Each tube 311 includes a plurality of radial ribs 312 extending radially outwards from an outer periphery of each tube 311 and extending across the arcuate groove 313. Each actuating member 51, 52 is hooked to an outer groove wall 314 of the arcuate groove 313. When each of the two pivotal casings 31 is actuated to pivot, each actuating member 51, 52 moves in the arcuate groove 313 in the circumferential direction, and each actuating member 51, 52 is actuated and lifted upwards by one of the plurality of radial ribs 132. Thus, the side strings 21 and 22 can be pulled upwards. On the other hand, when the pulling is not carried out, operation of the two side strings 21 and 22 for lifting and lowering of the slats 20 is not excessively interfered.

Although specific embodiments have been illustrated and described, numerous modifications and variations are still possible without departing from the scope of the invention. The scope of the invention is limited by the accompanying claims.

1. A venetian blind comprising a top frame receiving a coiling and uncoiling mechanism for folding and unfolding a plurality of slats of a slat unit, wherein an adjusting mechanism is mounted to the top frame and is configured to adjust a tilt angle of each of the plurality of slats, wherein the adjusting mechanism includes two pivotal casing each having a tube in a central portion thereof, wherein each tube includes a polygonal inner periphery, wherein an adjusting rod extends through the tubes, is securely fixed in the tubes, and has an outer periphery corresponding to the polygonal inner periphery of each tube, permitting driving of the two pivotal casings, wherein each of two ends of each of the two pivotal casings includes two opposite outer sides to which two ladder strings are disposed, respectively, wherein each of the two ladder strings has a lower end extending through and secured to each of the plurality of slats, wherein two side strings are wound around an outer periphery of the coiling and uncoiling mechanism, wherein each of the two side strings has a lower end extending through each of the plurality of slats and fixed to a bottommost slat of the slat unit, wherein two pegs are disposed in the top housing, are spaced from each other, and extend in a direction parallel to an axial direction of each tube, wherein each of the two side strings is hooked by an actuating member to extend through a spacing between the two pegs, wherein each actuating member interlocks with an associated pivotal casing to move in unison in a circumferential direction, wherein each actuating member moves together with the associated pivotal casing to change an angular position and an orientation thereof in the circumferential direction.

2. The venetian blind as claimed in claim 1, wherein each of the two pivotal casings has an arcuate groove at an inner side of a peripheral edge thereof, wherein each tube includes a plurality of radial ribs extending radially outwards from an outer periphery of each tube and extending across the arcuate groove, wherein each actuating member is hooked to an outer groove wall of the arcuate groove, wherein when each of the two pivotal casings is actuated to pivot, each actuating member moves in the arcuate groove in the circumferential direction, and one of the plurality of radial ribs extending across the arcuate groove lifts an associated actuating member.
